(19) United States
(12) Patent Application Publication
(10) Pub. No.: US 2011/0049779 A1
(43) Pub. Date: Mar. 3, 2011

(54) SUBSTRATE CARRIER DESIGN FOR IMPROVED PHOTOLUMINESCENCE UNIFORMITY

(75) Inventors: GLEN ERIC EGAMI, San Jose, CA (US); Brian H. Burrows, San Jose, CA (US); Kyawwin Maung, Daly City, CA (US)

(73) Assignee: APPLIED MATERIALS, INC., Santa Clara, CA (US)

(21) Appl. No.: 12/871,143

(22) Filed: Aug. 30, 2010

Related U.S. Application Data
(60) Provisional application No. 61/237,948, filed on Aug. 28, 2009.

(51) Int. Cl. B23Q 3/00; B23Q 7/00

(52) U.S. Cl. 269/289 R; 29/559

(57) ABSTRACT

Embodiments of the present invention relate to methods and apparatus for supporting substrates during processing. One embodiment of the present invention provides a substrate carrier comprising a body configured to provide structure support to one or more substrates. One or more pockets are formed in the body from a top surface. Each pocket is configured to retain one substrate by contacting only a portion of a back side of the substrate. Each pocket has a bottom surface and sidewalls surrounding the bottom surface. The sidewalls define an opening larger than a surface area of the substrate so that at least a majority portion of a bevel edge of the substrate is not in contact with the sidewalls.

### CROSS REFERENCE TO RELATED APPLICATIONS

This application claims benefit of U.S. Provisional Patent Application Ser. No. 61/237,948 (Attorney Docket No. 14197L), filed Aug. 28, 2009, which is incorporated herein by reference.

### BACKGROUND OF THE INVENTION

1. Field of the Invention

Embodiments of the present invention generally relate to methods and apparatus for semiconductor processing. More particularly, embodiments of the present invention relate to methods and apparatus for supporting substrates during processing.

2. Description of the Related Art

During semiconductor processing, substrate carriers are sometimes used to transfer and support a plurality of substrates, and hold the substrates in place during batch processing. For example, sapphire substrates used in manufacturing of light emitting diodes (LED) are usually processed in a batch with a batch of sapphire substrates disposed and transferred in a substrate carrier during processing. The substrates may deform because of heating, cooling and other factors during processing. Deformation of the substrates can cause the substrates to lose a solid contact with the substrate carrier. The deformed substrates may move relative to the substrate carrier during processing. As a result of non-solid contact and relative motion, thermal conduction between substrates and the substrate carrier becomes non-uniform from area to area within a substrates and from substrate to substrate. Non-uniform thermal conduction between substrates and substrate carrier reduces process uniformity within a substrate and from substrate to substrate.

FIG. 1 schematically illustrates a substrate 102 disposed on a substrate carrier 101 having a planar supporting surface 103. A back side of the substrate 102 is configured to contact the planar supporting surface 103 on the substrate carrier 101. When the substrate 102 deforms during processing, in this case, the substrate 102 bows up, the planar supporting surface 103 only contacts a portion of a bottom surface 102a of the substrate 102. The substrate 102 may wobble when the substrate carrier 101 moves during processing. When the substrate 102 is heated through the substrate carrier 101, the substrate 102 cannot be heated uniformly because only a portion of the substrate 102 is in direct contact with the substrate carrier 101. The wobbling and non-uniform heating usually result in non-uniform processing, such as non-uniform deposition, which may lead to defects in the final products. For example, in fabrication of LEDs, the process non-uniformity may cause the films deposited on the substrates to be non-uniform in thickness and quality within each substrate and among substrates. The thickness and quality of the film in a LED device directly affect the photoluminescence uniformity of the LED device.

Embodiments of the present invention provide methods and apparatus for supporting substrates during processing to overcome substrate deformation and improve process uniformity.

### SUMMARY OF THE INVENTION

Embodiments of the present invention generally relate to methods and apparatus for semiconductor processing. More particularly, embodiments of the present invention relate to methods and apparatus for supporting substrates during processing.

One embodiment provides a substrate carrier comprising a body configured to provide structure support to one or more substrates. One or more pockets are formed in the body from a top surface. Each pocket is configured to retain one substrate by contacting only a portion of a back side of the substrate. Each pocket has a bottom surface and sidewalls surrounding the bottom surface. The sidewalls define an opening larger than a surface area of the substrate so that at least a majority portion of a bevel edge of the substrate is not in contact with the sidewalls.

Another embodiment provides a substrate carrier comprising a substantially disk shaped body configured to support a plurality of substrates thereon, wherein the disk shaped body has a top surface and a plurality of pockets formed from the top surface, wherein each pocket is configured to retain and support one substrate. Each pocket has a bottom surface, sidewalls surrounding the bottom surface, wherein the bottom and sidewalls defining a recess, the recess has an opening larger than a surface area of the substrate so that at least a majority portion of a bevel edge of the substrate is not in contact with the disk shaped body, and a supporting surface extending from the bottom surface and configured to support a portion of a back side of the substrate.

Yet another embodiment provides a method comprising disposing a substrate in a pocket formed in a substrate carrier, wherein the substrate carrier is configured to support the substrate on a back side of the substrate, at least a portion of the back side of the substrate is not in contact with the substrate carrier, and the pocket has sidewalls defining an opening larger than a surface area of the substrate so that at least a major portion of an edge of the substrate is not in contact with the substrate carrier. The method further comprises transferring the substrate carrier and the substrate to a processing chamber, and heating the substrate disposed in the substrate carrier to an elevated temperature in the processing chamber.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a sectional view showing a portion of a substrate carrier of prior art.

FIG. 2 is a sectional side view of a metal organic chemical vapor deposition (MOCVD) chamber having a substrate carrier according to one embodiment of the present invention.

FIG. 3A is a top view of a substrate carrier according to one embodiment of the present invention.

FIG. 3B is a partial sectional view of the substrate carrier of FIG. 3A.

FIG. 4A is a partial top view of a substrate carrier according to one embodiment of the present invention.

FIG. 4B is a partial sectional view of the substrate carrier of FIG. 4A.

FIG. 5A is a partial top view of a substrate carrier according to one embodiment of the present invention.

FIG. 5B is a partial sectional view of the substrate carrier of FIG. 5A.

FIG. 6A is a partial top view of a substrate carrier according to one embodiment of the present invention.

FIG. 6B is a partial sectional view of the substrate carrier of FIG. 6A.

FIG. 7A is a partial top view of a substrate carrier according to one embodiment of the present invention.

FIG. 7B is a partial sectional view of the substrate carrier of FIG. 7A.

FIG. 8A is a partial top view of a substrate carrier according to one embodiment of the present invention.

FIG. 8B is a partial sectional view of the substrate carrier of FIG. 8A.

FIG. 9A is a partial top view of a substrate carrier according to one embodiment of the present invention.

FIG. 9B is a partial sectional view of the substrate carrier of FIG. 9A.

FIG. 10A is a partial top view of a substrate carrier according to one embodiment of the present invention.

FIG. 10B is a partial sectional view of the substrate carrier of FIG. 10A.

FIG. 11 is a perspective view of a substrate carrier having various supporting pockets according to one embodiment of the present invention.

FIG. 12 is a top view of a substrate carrier for supporting substrates with a flat according to one embodiment of the present invention.

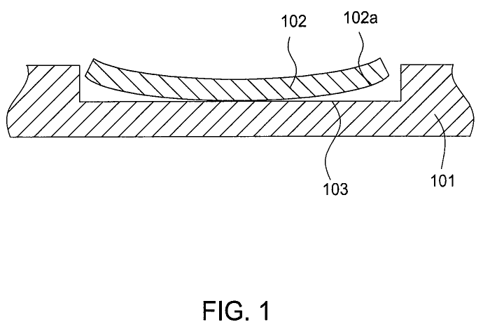

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present invention provide methods and apparatus for supporting and transferring substrates during processing. One embodiment of the present invention provides a substrate carrier that overcome substrate deformation and improves process uniformity. In one embodiment, the substrate carrier has one or more pockets for supporting substrates. Each pocket has a supporting surface for supporting a bottom surface of a substrate. The supporting surface is configured to contact a small portion of the bottom surface of the substrate, therefore, providing steady support in case of deformation of the substrate and avoid non-uniform heat conduction between the substrate and the substrate carrier. In one embodiment, each pocket is shaped to accommodate a substrate with a flat.

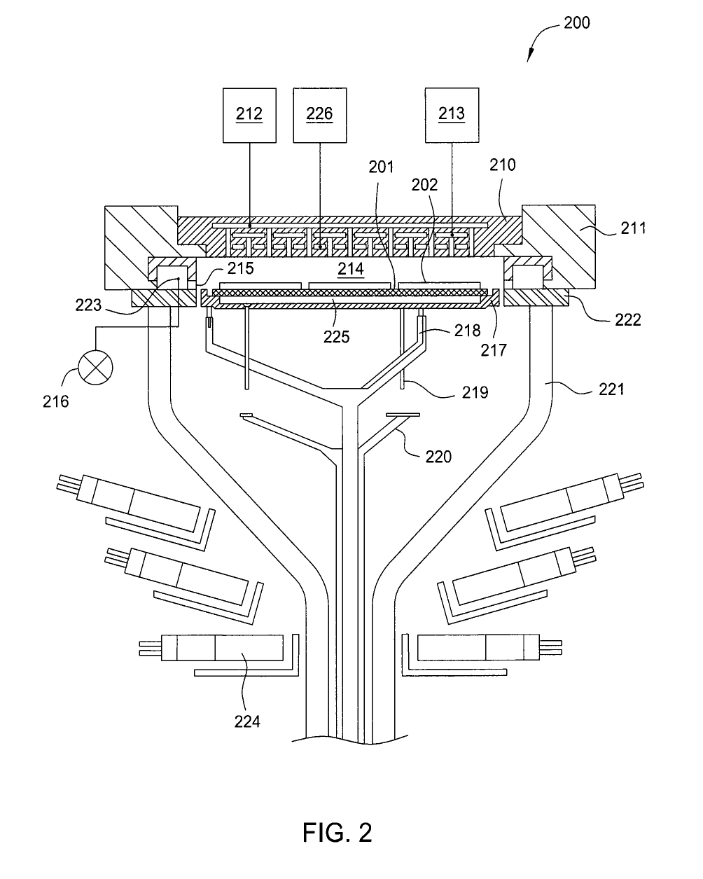

FIG. 2 is a sectional side view of a metal organic chemical vapor deposition (MOCVD) chamber 200 having a substrate carrier 201 according to one embodiment of the present invention. The MOCVD chamber 200 is configured to perform a thermal based vapor deposition process on a plurality of substrates 202, which are disposed on the substrate carrier 201 during processing. The substrates 202 may be heated up to about 450° C. to about 1100° C.

The MOCVD chamber 200 has a processing volume 214 defined by a showerhead assembly 210, sidewalls 211, an exhaust ring assembly 222, and a lower dome 221. The showerhead assembly 210 is connected to precursor sources 212, 213 and provides passages between the precursor sources 212, 213 and the processing volume 214. The showerhead assembly 210 is also connected to a cooling fluid source 226 configured to provide cooling to the showerhead assembly 210. The exhaust ring assembly 222 has a circular exhaust volume 223 which is coupled to a vacuum system 216. The circular exhaust volume 223 is in fluid communication with the processing volume 214 via a plurality of holes 215. The holes 215 are evenly distributed around the processing volume 214. During processing, precursors and processing gases flow into the processing volume 214 through the showerhead assembly 210 and exit the processing volume 214 under vacuum force from the vacuum system 216 via the plurality of holes 215 and the circular exhaust volume 223.

The MOCVD chamber 200 further comprises a substrate susceptor 217 configured to receive and support the substrate carrier 201 thereon. The susceptor 217 is disposed on a supporting shaft 218 which is configured to support and rotate the susceptor 217 and the substrate carrier 201 during processing. Three or more lifting pins 219 are movably disposed on the susceptor 217. A carrier lift shaft 220 is configured to move the lifting pins 219 up and down relative to the susceptor 217. When lifted, the lifting pins 219 can receive the substrate carrier 201 for a transfer mechanism or lift the substrate carrier 201 from the susceptor 219.

The MOCVD chamber 200 further comprises a heating assembly 224 configured to provide heat energy to the processing volume 214 via the lower dome 221, which is usually made from infrared transparent material, such as quartz. The substrates 202 are heated by the heating assembly 224 through the susceptor 219 and the substrate carrier 201. In one embodiment, the susceptor 219 only contacts the substrate carrier 201 near an edge region of the substrate carrier 201. A uniform spacing 225 may be formed between the substrate carrier 201 and the susceptor 219 to assure uniform heat transferring between the susceptor 219 and the substrate carrier 201. In one embodiment, the substrate carrier 201 has a surface roughness of about 32 micron.

The substrate carrier 201 is designed to provide uniform heat transfer between the substrate carrier 201 and each substrate 202. The substrate carrier 201 is also designed to provide a steady support to each substrate 202 during processing.

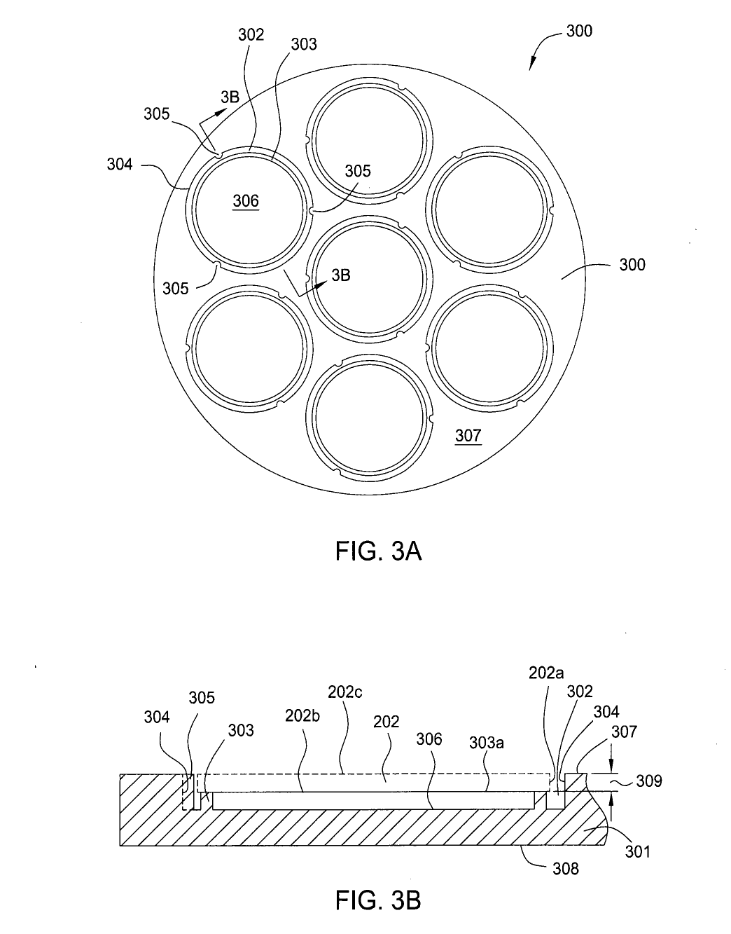

FIG. 3A is a top view of a substrate carrier 300 according to one embodiment of the present invention. FIG. 3B is partial side view the substrate carrier 300 of FIG. 3A. The substrate carrier 300 may be used in the MOCVD chamber 200 of FIG. 2.

The substrate carrier 300 generally comprises a body 301 configured to provide structural support to one or more substrates 202 thereon. In one embodiment, the body 301 may have a substantially disk shape. The body 301 may comprise a material which has similar thermal properties, such as similar thermal expansion, with as the substrates 202 to avoid unnecessary relative motion between the body 301 and the substrates 202 during heating and/or cooling. The body 301 may comprise silicon carbide. In one embodiment, the body 301 is formed from solid silicon carbide. In another embodiment, the body 301 comprises a core and a coating over the core formed by a chemical vapor deposition process. The body 301 may have a core comprising graphite and a silicon carbide coating formed by CVD.

The body 301 may be a circular disk having a planar back surface 308 and a top surface 307 with a plurality of pockets 302 formed thereon. Each pocket 302 is configured to retain one substrate 202 therein. The plurality of pockets 302 may be distributed on the body 301 to effectively use surface areas of the body 301. In one embodiment, the plurality of pockets 302 are distributed in a circular manner. For example, one of the plurality of pockets 302 is positioned in the centered of the disk shaped body 301, and seven pockets 302 forms a circle surrounding the pocket 302 in the center as shown in FIG. 3A. The plurality of pockets 302 may form two or more concentric circles on the disk shaped body 301 depending on sizes of the substrate carrier 300 and the substrate 202.

The pockets 302 are generally recesses formed in the body 301. Each pocket 302 has sidewalls 304 and a bottom surface 306 defining a recess. The sidewalls 304 define an area slightly larger than the substrate 202 so that an edge 202a of the substrate 202 is not in contact with the sidewalls 304. In one embodiment, the inner diameter of each pocket 302 may be lager than a diameter of the substrate being supported for up to about 0.05 inch (1.27 mm).

In one embodiment, a raised ring 303 extending from the bottom surface 306 provides a supporting surface 303a for supporting the substrate 202 on a bottom surface 202b of the substrate 202. The supporting surface 303a only contacts a small portion of the bottom surface 202b and a majority of the bottom surface 202b is not in direct contact with the body 301. By reducing contact areas between the substrate 202 and the substrate carrier 300, deformation of the substrate 202, for example bowing, will less likely to cause the substrate 202 to become unstable on the substrate carrier 300. In one embodiment, the supporting surface 303a has a surface roughness of about 0.2 micron to about 1.6 micron.

In one embodiment, a plurality of stops 305 extend inward from the sidewalls 304 into the pocket 302. The stops 305 are configured to constrain the substrate 202 from moving laterally. In one embodiment, the tip of the stops 305 form a circle with a diameter between about 3.94 inch (100.01 mm) to about 3.99 inch (101.35 mm) for supporting substrate with a diameter of about 3.93 inch (100 mm).

In one embodiment, an elevation difference 309 between the supporting surface 303a and the top surface 307 of the body is substantially similar to the thickness of the substrate 202 held therein. As a result, a top surface 202c of the substrate 202 levels with the top surface 307 of the body 301. Leveling the top surface 202c of the substrate 202 and the top surface 307 of the substrate carrier 300 reduces interruptions to fluid flow over the substrate carrier 300 during process.

In one embodiment, the body 300 has a thickness about 0.06 inch (1.5 mm) to about 0.12 inch (3.0 mm). In one embodiment, the height difference between the bottom surface 306 and the supporting surface 303a is about 0.005 inch (0.13 mm) to about 0.02 inch (0.5 mm). The substrate carrier 300 may be formed by hot press.

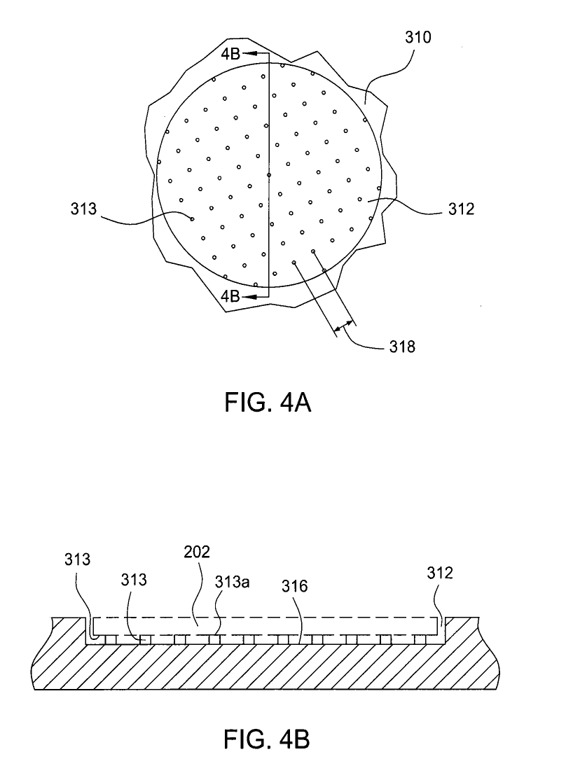

Substrate carrier of the present invention may have alternative substrate supporting pockets. FIGS. 4-10 describe substrate carriers with alternative substrate supporting pockets.

FIG. 4A is a partial top view of a substrate carrier 310 in according to one embodiment of the present invention. FIG. 4B is a partial sectional view the substrate carrier 310 of FIG. 4A. The substrate carrier 310 is similar to the substrate carrier 300 of FIG. 3A with a plurality of pockets 312 with a different design. Each pocket 312 is configured to retain one substrate 202. The pocket 312 has a supporting surface 313a defined by top surfaces of a plurality of mesas 313 formed on a bottom surface 316 of the pocket 312. In one embodiment, the plurality of mesas 313 are evenly distributed on the bottom surface 316. Each mesa 313 may be circular and has a diameter of about 0.02 inch (0.5 mm) to about 0.06 inch (1.5 mm) and a height of about 0.005 inch (0.12 mm) to about 0.015 inch (0.38 mm). The distance 318 between neighboring mesas 313 may be between about 0.25 inch (6.35 mm) to about 0.75 inch (19.0 mm). The top surface of each mesa 313 may have a surface roughness of about 0.2 micron to about 1.6 micron. The plurality of mesas 313 may be formed by bead blasting.

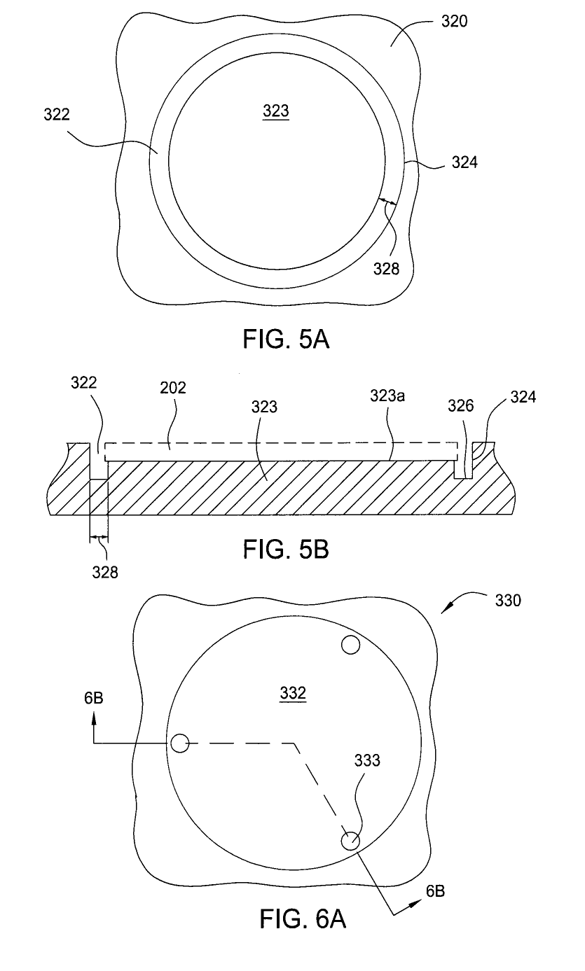

FIG. 5A is a partial top view of a substrate carrier 320 according to one embodiment of the present invention. FIG. 5B is a partial sectional view of the substrate carrier 320 of FIG. 5A.

The substrate carrier 320 is similar to the substrate carrier 300 of FIG. 3A with a plurality of pockets 322 with a different design. Each pocket 322 is configured to retain one substrate 202. The pocket 322 has a supporting surface 323a defined by a top surface of an island 323 formed on a bottom surface 326 of the pocket 322. In one embodiment, the raised island 323 is circular. A radius difference 328 between sidewall 324 and the raised island 323 is between about 0.1 inch (2.54 mm) to about 0.25 inch (6.35 mm). In one embodiment, the raised island 323 has a height of about 0.005 inch (0.13 mm) to about 0.015 inch (0.38 mm). The top surface of the raised island 323 may have a surface roughness of about 0.2 micron to about 1.6 micron.

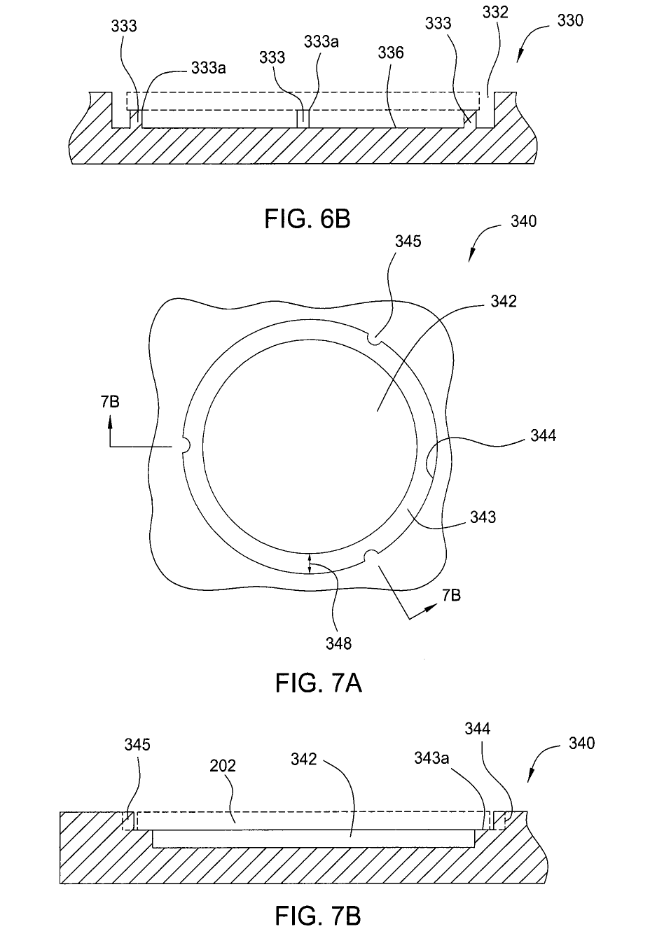

FIG. 6A is a partial top view of a substrate carrier 330 according to one embodiment of the present invention. FIG. 6B is a partial sectional view of the substrate carrier 330 of FIG. 6A. The substrate carrier 330 is similar to the substrate carrier 300 of FIG. 3A with a plurality of pockets 332 having a different design. Each pocket 332 is configured to retain one substrate 202. The pocket 332 has a three or more raised islands 333 extending from a bottom surface 336. A supporting surface 333a is defined by top surfaces of the three or more raised islands 333. In one embodiment, each pocket 332 has three raised islands 333 located to contact the substrate 202 near the edge of the pocket 332. The three raised islands 333 may be 120 degrees apart from one another. Each raised island 333 may be circular and have a diameter of about 0.02 inch (0.5 mm) to about 0.06 inch (1.5 mm) and a height of about 0.005 inch (0.12 mm) to about 0.015 inch (0.38 mm). The top surface of each raised island 333 may have a surface roughness of about 0.2 micron to about 1.6 micron.

FIG. 7A is a partial top view of a substrate carrier 340 according to one embodiment of the present invention. FIG. 7B is a partial sectional view the substrate carrier 340 of FIG. 7A. The substrate carrier 340 is similar to the substrate carrier 300 of FIG. 3A with a plurality of pockets 342 with a different design. Each pocket 342 is configured to retain one substrate 202. The pocket 342 is similar to the pocket 302 of the substrate carrier 300 of FIG. 3A, except that the pocket 342 has a supporting surface 343a defined by a step 343 directly extended inwardly from sidewalls 344. Each pocket 342 has three or more stops 345 inwardly extending from sidewalls 344. The stops 345 are configured to limit motions of the substrate 202 retained in the pocket 342. In one embodiment, the step 343 has a width 348 of about 0.5 inch (12.7 mm) to about 1.0 inch (25.4 mm). The height of the step 343 may be between about 0.005 inch (0.12 mm) to about 0.015 inch (0.38 mm). The surface roughness of the step 343 may be about 0.2 micron to about 1.6 micron.

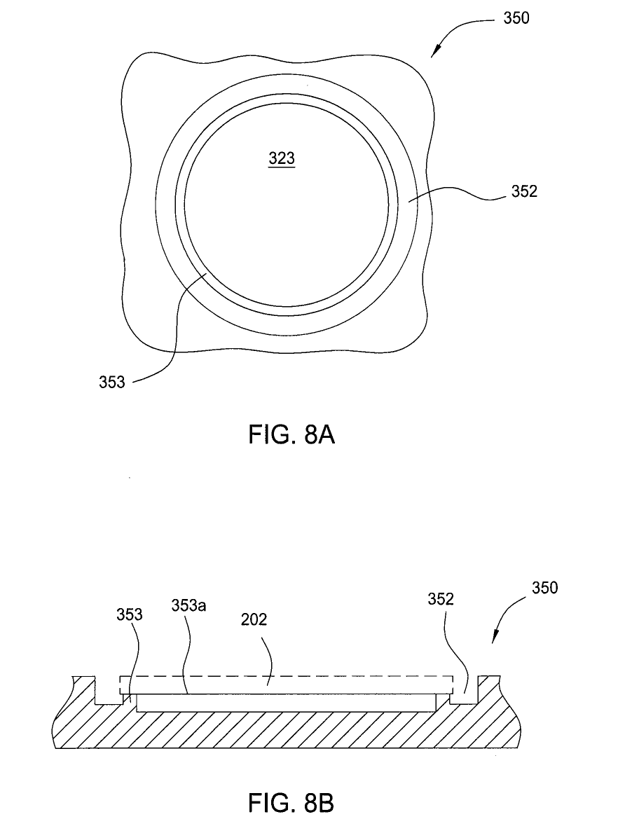

FIG. 8A is a partial top view of a substrate carrier 350 according to one embodiment of the present invention. FIG. 8B is a sectional side view the substrate carrier 350 of FIG. 8A. The substrate carrier 350 is similar to the substrate carrier 300 of FIG. 3A with a plurality of pockets 352 with a different design. Each pocket 352 is configured to retain one substrate 202. Similar to the pocket 302 of FIG. 3A, the pocket 352 has a raised ring 353 with a supporting surface 353a for supporting the substrate 202 on a bottom surface 202b of the substrate 202. Unlike the pocket 302 of the substrate carrier 300 of FIG. 3A, the pocket 352 does not have stops 305 extending from sidewalls.

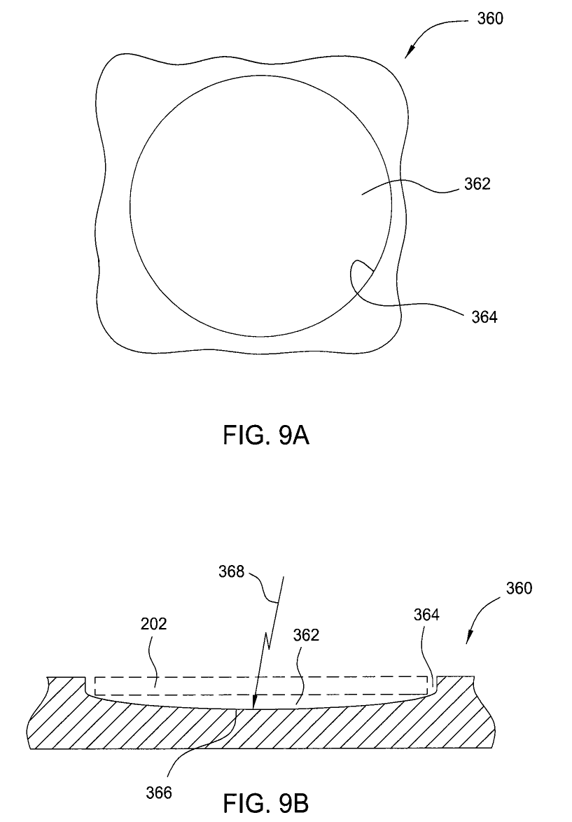

FIG. 9A is a partial top view of a substrate carrier 360 according to one embodiment of the present invention. FIG. 9B is a sectional view of the substrate carrier 360 of FIG. 9A. The substrate carrier 360 is similar to the substrate carrier 300 of FIG. 3A with a plurality of pockets 362 with a different design. The pocket 362 is defined by a sidewall 364 and a bottom surface 366. In one embodiment, the bottom surface 366 shapes like a reversed dome and the depth of the pocket 362 increases from the sidewall 364 to the center. The reversed dome bottom surface 366 provides tolerance to substrate bowing and other deformation. Additionally, the reserved dome bottom surface 366 also enables the pocket 362 to support substrates of different sizes. The radius 368 of the reversed dome bottom surface 366 may be between about 195 inch (4,953 mm) to about 985 inch (25,019 mm). The surface roughness of the bottom surface 366 is about 0.2 micron to about 1.6 micron.

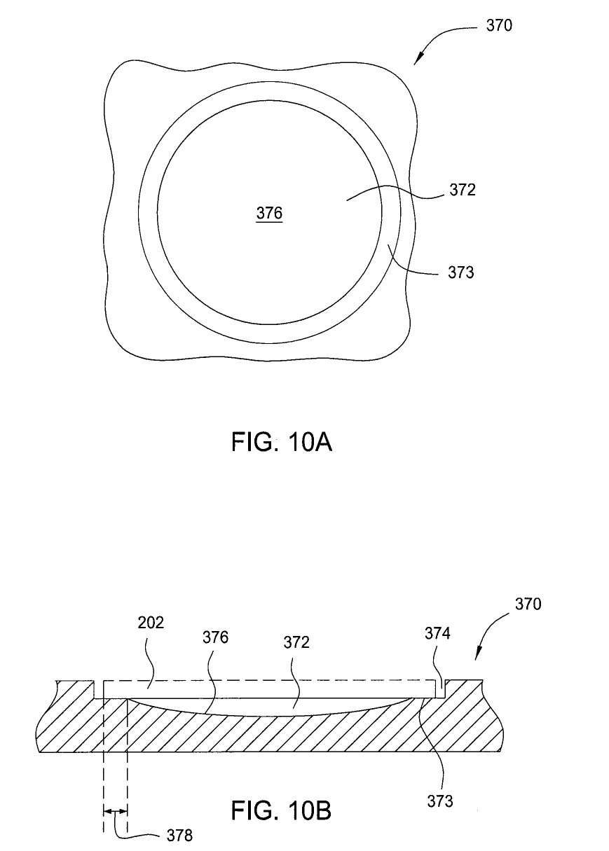

FIG. 10A is a partial top view of a substrate carrier 370 according to one embodiment of the present invention. FIG. 10B is a sectional view of the substrate carrier 370 of FIG. 10A. The substrate carrier 370 is similar to the substrate carrier 300 of FIG. 3A with a plurality of pockets 372 with a different design. The pocket 372 is similar to the pocket 362 of FIG. 9A except that the pocket 372 has a flat supporting ring 373 extending inwardly from sidewalls 374. A bottom surface 376 extends inwardly from the flat supporting ring 373. The bottom surface 376 has a shape of reversed dome. The flat supporting ring 373 provides a supporting surface for contacting the substrate 202 during processing and the reversed dome shaped bottom surface 376 provides room to tolerant deformation of the substrate 202. In one embodiment, the flat supporting ring 373 has a width of about 0.02 inch (0.5 mm) to about 0.08 inch (2 mm). In one embodiment, the radius 378 of the reversed dome bottom surface 376 is about 195 inch (4,953 mm) to about 985 inch (25,019 mm). In one embodiment, the surface roughness of the bottom surface 376 is about 0.2 micron to about 1.6 micron.

It should be noted that elements in the pockets 302, 312, 322, 332, 342, 352, 362, 372 may be combined or re-grouped to achieve desired effect according to a particular process.

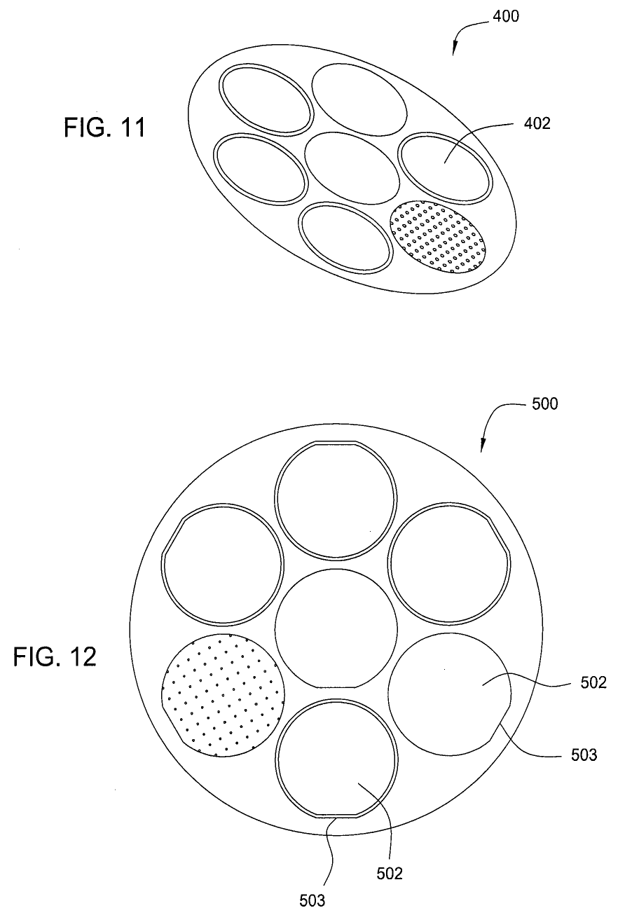

Substrate carriers of the present invention may also include plurality of pockets with different designs. FIG. 11 is a schematic view of a substrate carrier 400 according to one embodiment of the present invention. The substrate carrier 400 has a plurality of pockets 402. Each pocket 402 is configured to support one substrate therein. Each pocket 402 has a different design. The pockets 402 may be similar to any one of the pockets 302, 312, 322, 332, 342, 352, 362, 372, and any combination of elements in the pockets 302, 312, 322, 332, 342, 352, 362, 372. The substrate carrier 400 may be used as a test substrate carrier used to efficiently determine which pocket design suits a particular process the best.

FIG. 12 is a schematic view of a substrate carrier 500 for supporting substrates with flats. The substrate carrier 500 is similar to the substrate carrier 300 or 400 except the substrate carrier 500 has a plurality of pockets 502 shaped with a flat 503. The flat 503 in each pocket 502 corresponds to the flat in a substrate being processed to prevent the substrate from rotating within the each pocket 502. In one embodiment, the flats 503 of the plurality of pockets 502 may be located in a symmetrical manner. As shown in FIG. 12, each flat 503 faces away from a center of the substrate carrier 500. It should be noted that a flat can be incorporated in all other embodiments of the present invention, such as substrate carriers 300, 310, 320, 330, 340, 350, 360, 370 and 400.

Even though, a MOCVD chamber is described in the description above, the substrate carrier and methods for supporting substrates in accordance with embodiment of the present invention can be used in any suitable processing chambers, or during transferring between processing, or during storage. For example, the substrate carrier in accordance with embodiments of the present invention can be used in hydride vapor phase epitaxy (HVPE) chamber, chemical vapor deposition chamber, and rapid thermal processing chamber.

While the foregoing is directed to embodiments of the present invention, other and further embodiments of the invention may be devised without departing from the basic scope thereof, and the scope thereof is determined by the claims that follow.

What is claimed is:

1. A substrate carrier, comprising:
a body configured to provide structure support to one or more substrates, wherein one or more pockets are formed in the body from a top surface, each pocket is configured to retain one substrate by contacting only a portion of a back side of the substrate, each pocket has:
a bottom surface; and
sidewalls surrounding the bottom surface, wherein the sidewalls define an opening larger than a surface area of the substrate so that at least a majority portion of a bevel edge of the substrate is not in contact with the sidewalls.

2. The substrate carrier of claim 1, wherein the body is formed from materials suitable for heating the substrates to a temperature between about 450° C. to about 1100° C. while supporting the substrates.

3. The substrate carrier of claim 2, wherein each pocket has a supporting surface defined by one or more raised areas extended from the bottom surface of the pocket, and the supporting surface is configured to contact a portion of the back side of the substrate.

4. The substrate carrier of claim 3, wherein a height difference between the supporting surface and the top surface of the body is substantially similar to a thickness of the substrate so that a front side of the substrate levels with the top surface of the body when the substrate is disposed in the pocket.

5. The substrate carrier of claim 3, wherein the one or more raised areas comprise a plurality of raised islands distributed on the bottom surface of the pocket.

6. The substrate carrier of claim 3, wherein the one or more raised areas comprise a circular ring having a diameter smaller than a diameter of the substrate.

7. The substrate carrier of claim 6, wherein each pocket has a plurality of stops extending inwards from the sidewalls, and the stops are configured to limit movement of the substrate retained therein.

8. The substrate carrier of claim 2, wherein the bottom surface comprises a curved surface shaped like a reversed dome.

9. The substrate carrier of claim 8, wherein the bottom surface comprises a flat surface surrounding the curved surface, and the flat surface is configured to support the back side of the substrate.

10. The substrate carrier of claim 1, wherein the body is formed one of silicon carbide, graphite, and graphite coated with silicon carbide.

11. A substrate carrier, comprising:
a substantially disk shaped body configured to support a plurality of substrates thereon, wherein the disk shaped body has a top surface and a plurality of pockets formed from the top surface, wherein each pocket is configured to retain and support one substrate, and each pocket has
a bottom surface;
sidewalls surrounding the bottom surface, wherein the bottom and sidewalls defining a recess, the recess has an opening larger than a surface area of the substrate so that at least a majority portion of a bevel edge of the substrate is not in contact with the disk shaped body; and
a supporting surface extending from the bottom surface and configured to support a portion of a back side of the substrate.

12. The substrate carrier of claim 11, wherein the disk shaped body comprises silicon carbide and is configured to support sapphire substrates.

13. The substrate carrier of claim 12, wherein the disk shaped body is formed from a graphite core with a silicon carbide coating.

14. The substrate carrier of claim 11, wherein the supporting surface is defined by top surfaces of one or more raised areas extended from the bottom surface of the pocket.

15. The substrate carrier of claim 14, the one or more raised areas comprise a circular ring having a diameter smaller than a diameter of the substrate.

16. The substrate carrier of claim 14, the one or more raised areas comprise a plurality of raised islands distributed on the bottom of the pocket.

17. The substrate carrier of claim 11, wherein a height difference between the top surface and the supporting surface is substantially similar to a thickness of the substrate so that a front side of the substrate substantially levels with the top surface of the disk shaped body when the substrate is disposed in the pocket.

18. A method for supporting substrates during processing, comprising:
disposing a substrate in a pocket formed in a substrate carrier, wherein the substrate carrier is configured to support the substrate on a back side of the substrate, at least a portion of the back side of the substrate is not in contact with the substrate carrier, and the pocket has sidewalls defining an opening larger than a surface area of the substrate so that at least a major portion of an edge of the substrate is not in contact with the substrate carrier;
transferring the substrate carrier and the substrate to a processing chamber; and
heating the substrate disposed in the substrate carrier to an elevated temperature in the processing chamber.

19. The method of claim 18, wherein disposing the substrate comprises positioning the substrate on one or more raised areas extending from a bottom of the pocket.

20. The method of claim 18, wherein heating the substrate comprises heating the substrate to a temperature between about 450° C. to about 1100° C.
